(19) United States
(12) Patent Application Publication
(10) Pub. No.: US 2007/0264952 A1
(43) Pub. Date: Nov. 15, 2007

(54) METHOD AND APPARATUS FOR ALLOWING OR DENYING NETWORK ACCESS

(75) Inventors: Gregory J. Buchwald, Crystal Lake, IL (US); Lawrence M. Ecklund, Wheaton, IL (US); Stephen L. Kuffner, Algonquin, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/382,957

(22) Filed: May 12, 2006

(51) Int. Cl. H04B 7/00; H04B 1/18

(52) U.S. Cl. 455/186.1; 455/421

(57) ABSTRACT

A cluster management module will receive a transmission from a subscriber module and estimate a range for a subscriber module based on the received transmission. A receive power for the transmission will be obtained and a transmit power for the subscriber module will be determined based on the range of the subscriber module and the receive power of the transmission. Network access will be allowed or denied based on the transmit power of the subscriber module. In a second embodiment, an azimuth angle is additionally determined from the received transmission, and an approximate location of the subscriber module is determined. Network access is then allowed or denied based on the transmit power of the subscriber module and additionally based on the location of the subscriber module.

### FIELD OF THE INVENTION

The present invention relates generally to wireless communication systems and in particular, to a method and apparatus for allowing or denying network access within such wireless communication systems.

### BACKGROUND OF THE INVENTION

In a cognitive radio system of the type considered for use by IEEE 802.22, the radio system will utilize spectrum licensed to another system using an unlicensed, opportunistic approach. With this approach, the radio system will share the spectrum with licensed incumbents as well as those operating under authorization on a secondary basis. Under these conditions, it is imperative that any user in the cognitive radio system not interfere with licensed users. In fact, the United States Federal Communication Commission (FCC) has proposed maximum power levels to be utilized by fixed, unlicensed devices in order to reduce interference to licensed users.

Because of such limitations put on unlicensed users of spectrum, professional installers are typically required to insure that all installed equipment performs within the specifications set by the FCC. These “truck rolls” increase installation costs considerably. It would be beneficial, therefore, if a system could be employed that would eliminate the need for a truck roll and still insure that installed customer equipment is performing within the limits set by the FCC. In such a system, it would also be beneficial if network access was denied if the customer's equipment operates outside preset limits (e.g., those set by the FCC). Therefore, a need exists for a method and apparatus for allowing or denying network access within wireless communication systems for users operating outside preset limits.

### BRIEF DESCRIPTION OF THE DRAWINGS

FIG. 1 is a block diagram of a communication system.

FIG. 2 illustrates subscriber module transmissions of varying powers.

FIG. 3 is a block diagram of a cluster management module of FIG. 1.

FIG. 4 is a flow chart showing operation of the cluster management module of FIG. 2 in accordance with a first embodiment of the present invention.

FIG. 5 is a flow chart showing operation of the cluster management module of FIG. 2 in accordance with a second embodiment of the present invention.

### DETAILED DESCRIPTION OF THE DRAWINGS

In order to address the above-mentioned need, a method and apparatus for allowing or denying network access within a wireless communication system is provided herein. During operation, a cluster management module will receive a transmission from a subscriber module and determine a range for a subscriber module based on the received transmission. A receive power for the transmission will be obtained and a transmit power for the subscriber module will be determined based on the range of the subscriber module and the receive power of the transmission. Network access will be allowed or denied based on the transmit power of the subscriber module. In a second embodiment of the present invention an azimuth angle is additionally determined from the received transmission, and an approximate location of the subscriber module is determined. Network access is then allowed or denied based on the transmit power of the subscriber module and additionally based on the location of the subscriber module.

Because the cluster management module will deny network access to those subscriber modules transmitting with power levels above FCC guidelines, substantial system cost reductions may be achieved since no truck roll will be necessary to make sure subscriber modules are transmitting within FCC guidelines. This allows for self-installation of subscriber modules by the customer since performance can be verified. Additionally, network access will be denied if a customer tampers with the subscriber module in order to transmit with power levels above those allowed.

The present invention encompasses a method for allowing network access. The method comprises the steps of receiving a transmission from a subscriber module, estimating a range for the subscriber module based on the received transmission, and measuring a receive power for the received transmission. A transmit power for the subscriber module is determined based on the range of the subscriber module and the receive power of the subscriber module, and network access is allowed or denied for the subscriber module based on the transmit power of the subscriber module.

The present invention additionally encompasses a method for allowing network access. The method comprises the steps of receiving an over-the-air transmission from a subscriber module, determining a round-trip-delay for the over-the-air transmission, estimating range for the subscriber module based on the round-trip delay, and measuring a receive power for the over-the-air transmission. A transmit power for the subscriber module is determined based on the range of the subscriber module and the receive power of the subscriber module, and network access for the subscriber module is allowed or denied based on the transmit power of the subscriber module.

The present invention additionally encompasses an apparatus comprising an access point receiving a transmission from a subscriber module, location-finding equipment determines a range for the subscriber module based on the received transmission, and an RSS computer measuring a receive power for the received transmission. A transmit-power computer is provided for determining a transmit power for the subscriber module based on the range of the subscriber module and the receive power of the subscriber module. Finally, logic circuitry allows or denies network access for the subscriber module based on the transmit power of the subscriber module.

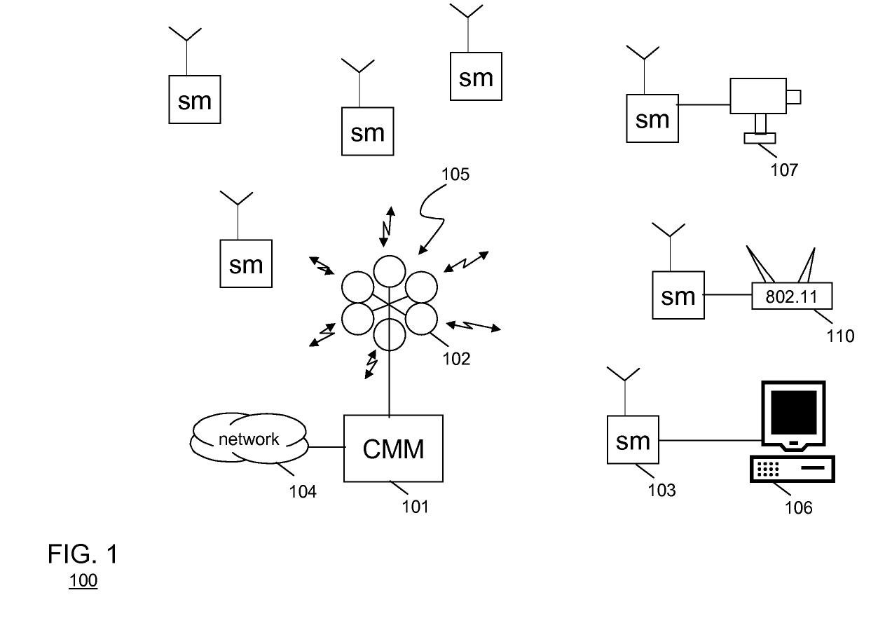

Turning now to the drawings, wherein like numerals designate like components, FIG. 1 is a block diagram of communication system 100. Communication system 100 comprises a Motorola Canopy™ Broadband Wireless Internet Platform available from Motorola, Inc. However in alternate embodiments of the present invention, communication system 100 may comprise any communication system requiring the denial of network access for users operating outside particular operational limits. As shown, communication system 100 comprises cluster management module 101, a plurality of access points 102 (only one labeled), a plurality of subscriber modules or nodes 103 (only one labeled), and wide-area network 104. All elements 101-103 are available from Motorola, Inc. (Motorola Inc. is located at 1301 East Algonquin Road, Schaumburg, Ill. 60196). It is contemplated that elements within communication system 100 are configured in well known manners with processors, memories, instruction sets, and the like, which function in any suitable manner to perform the function set forth herein.

During operation, data is transmitted to and from subscriber modules 103 via over-the-air communication. Data destined to subscriber modules 103 is received from network 104. The data is passed to cluster management module 101 where it is routed to the appropriate access point 102. In particular, cluster management module 101 comprises an Ethernet switch that directs data to an appropriate access point 102. Each access point 102 comprises a direct 100 baseT Ethernet connection to cluster management module 101. Each access point 102 is designed to serve up to 200 subscriber modules 103, with six access points 102 in cluster 105 capable of serving 1200 subscriber modules 103. Once data is received by an access point, the access point determines the appropriate subscriber module 103 and transfers the data to the subscriber module via an over-the-air communication link. Each subscriber module 103 comprises a direct Ethernet connection to local equipment, providing a remote data feed. For example subscriber module 103 may provide a backhaul to 802.11 hot spot 110, or deliver internet access to personal computer 106, or a backhaul to internet webcam 107.

When data is to be transmitted from subscriber 103 module to network 104, subscriber module 103 will transmit the data via the over-the-air communication link to cluster 105, where it will be received by the appropriate access point 102. The data will be passed to cluster management module 101 via the direct 100 baseT Ethernet connection, and eventually to network 104.

As discussed above, it is imperative that any subscriber module's transmissions not interfere with licensed users. Because of this, it would be beneficial if network access was denied when any subscriber module 103 performs outside satisfactory operational limits (e.g., those set by the FCC). In order to address this issue, in a first embodiment of the present invention, cluster management module 101 will receive a transmission from a subscriber module and determine a range for a subscriber module based on the received transmission. A receive power for the transmission will be obtained and a transmit power for the subscriber module will be determined based on the estimated range of the subscriber module and the receive power of the transmission. Network access will be allowed or denied based on the transmit power of the subscriber module.

More particularly, cluster management module 101 will instruct an access point to transmit a known reference signal at a known time. When a subscriber module receives the signal, it will report the time of reception, along with turn-around timing criteria as a header or other signaling form along with the data to be broadcast. The information sent by the subscriber module includes not only the time stamp of when the signal was received, but can also include the propagation time through the receiver/demodulator of the subscriber module as well. All radio circuits exhibit some delay; the free space propagation is well known, however, the delay through the circuit itself due to sampling time, clock rates of data, etc., varies by design. It is beneficial to include a known factor, k, to the time stamped, received and transponded signal back to the host unit/WRAN.

Once the time of reception, along with turn-around timing criteria is received, the calculation of the subscriber modules range is done by cluster management module 101 by using the fact that there exists approximately 11 us per round trip/radar mile plus processing time. With the range of the subscriber module and with the received power at the base station known, a transmit power of the subscriber module may be obtained by utilizing known propagation losses along the signal path. Denial of service takes place if the calculated transmit power of the subscriber module strength exceeds a specified level. Factors such as Raleigh fading and constructive interference can be taken into consideration over the course of several samples such that service is not denied unless the signal strength is consistently too high.

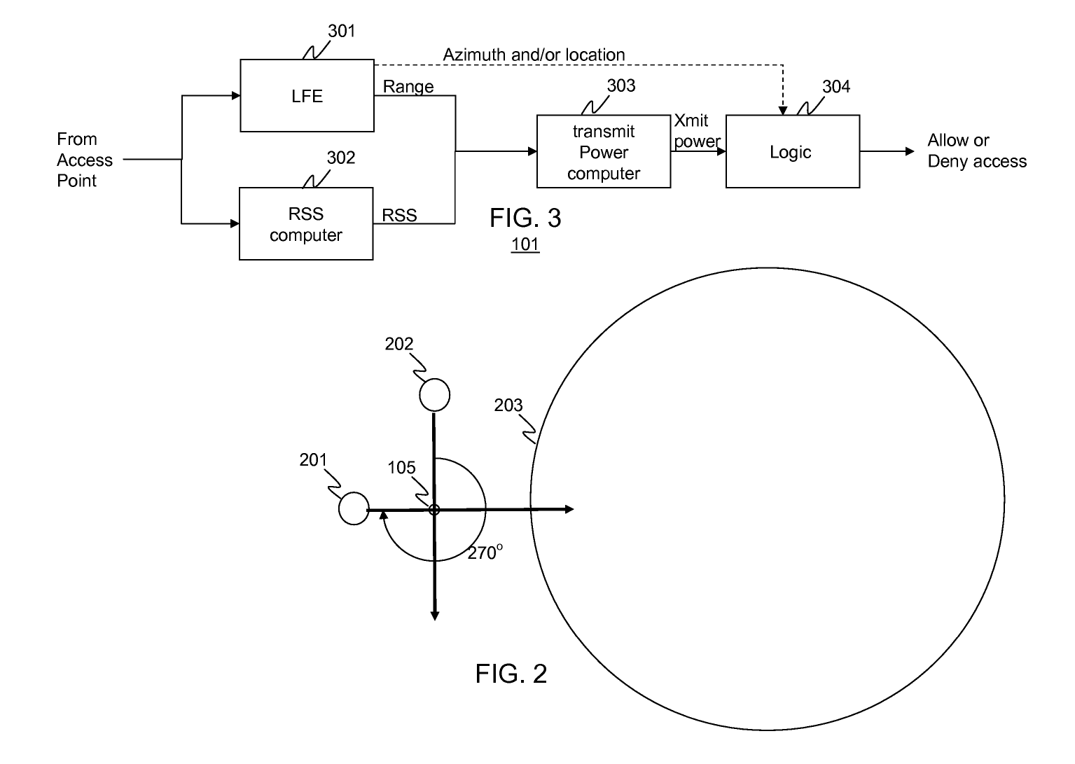

In a second embodiment of the present invention an azimuth angle is additionally determined from the received transmission, and an approximate location of the subscriber module is determined. Network access is then allowed or denied based on the transmit power of the subscriber module and additionally based on the location of the subscriber module. In the second embodiment, subscriber modules are allowed to transmit at a maximum power that depends upon their azimuth angle. This is illustrated in FIG. 2.

As shown in FIG. 2, subscriber modules 201 and 202 are both directionally transmitting signals to cluster 105 with the same power (illustrated by the arrows emanating from each subscriber module). Additionally, in FIG. 2, there exists an area 203 where subscriber module's transmissions will interfere with a licensed user. Because of this, subscriber module 201 will interfere with units within area 203, while subscriber module 202 will not interfere with those units. Thus, subscriber module 202, transmitting at an azimuth of 0 degrees will be allowed to transmit while subscriber module 201, transmitting at an azimuth of 270 degrees, will be prevented from transmitting at that power level.

FIG. 3 is a block diagram of a cluster management module 101. As shown, module 101 comprises location-finding equipment (LFE) 301, received signal strength (RSS) computer 302, transmit-power computer 303, and logic circuitry 304. During operation, a subscriber module's transmit signal is received by LFE 301 and RSS computer 302. RSS computer analyzes the received signal and calculates the received signal strength of a received signal.

In the first embodiment of the present invention, LFE 301 determines a range for subscriber modules by receiving the time of reception as a header transmitted from the subscriber module. Once this information is received, the calculation of the subscriber modules range is done by LFE 301 by using the fact that there exists approximately 11 us per round-trip/radar mile plus processing time. Thus, the round-trip delay between the cluster management module and the subscriber module corresponds to a distance between the subscriber module and the cluster management module.

In the second embodiment of the present invention, LFE 301 additionally calculates the azimuth angle and/or an approximate location of the subscriber module by determining an energy of the signal at each of the multiple antennas and then correlating the energy at each of the multiple antennas to an azimuth angle.

Range and RSS are output to transmit-power computer 303 where the transmit-power computer calculates the transmission power of the subscriber module. In particular, the free space propagation loss from the subscriber module, based on calculated distance (as measured by measured propagation delay), can be easily calculated. This factor provides a starting basis for determination of the subscriber transmitted power. The calculation can refined through various known means, such as inputting the exact location of the subscriber module, or its local street address location, from which a program, such as one which does Longley-Rice point to point propagation loss analysis can be employed. Alternatively, knowledge learned from several subscriber modules in near geographic location to each other, can also be utilized to refine the propagation loss over a smaller region.

Any of the above methods are then used to set a threshold, based on the highest possible received energy from a subscriber module assuming the maximum legal power (often times referred to as Effective Radiated Power) that is transmitted by the subscriber module. If the received energy from the subscriber module exceeds the calculated limit, access is denied.

Logic circuitry 304 receives the transmit power and optionally receives the azimuth angle and/or location for the subscriber module's transmission and determines whether or not to deny network access. As discussed above, in the first embodiment of the present invention, the decision to deny or allow network access is based solely on the transmit power of the subscriber module. However, in the second embodiment of the present invention, the decision to deny or allow network access is additionally based on the azimuth angle and/or location of the subscriber module.

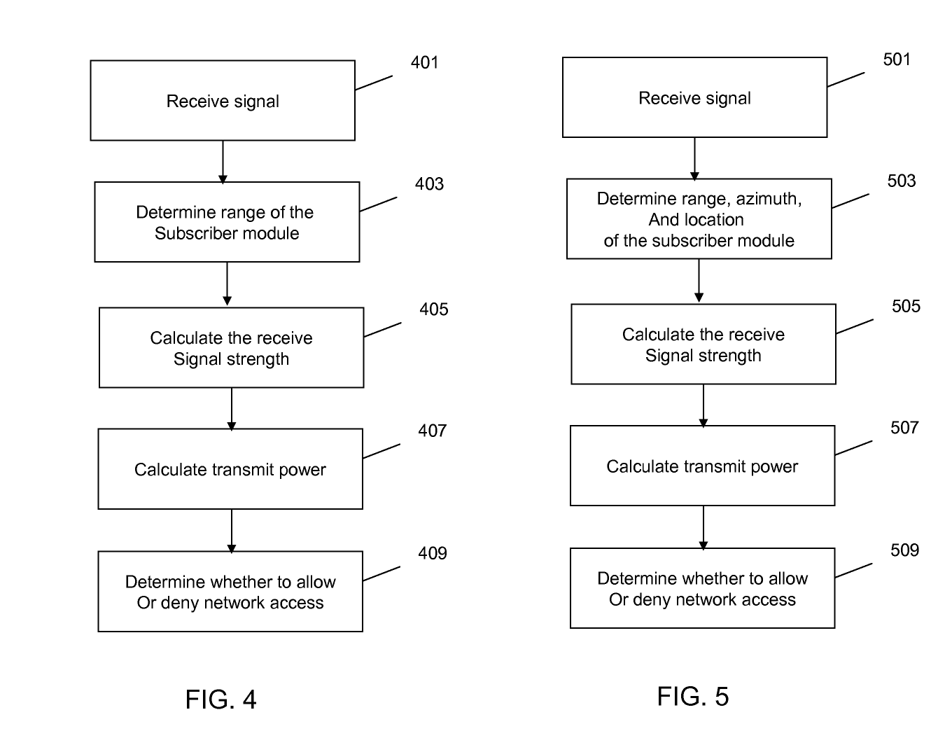

FIG. 4 is a flow chart showing operation of the cluster management module of FIG. 2 in accordance with the first embodiment of the present invention. As discussed above, in the first embodiment of the present invention network access is allowed or denied based on the transmit power of the subscriber module (i.e., power at which the subscriber module transmits). The logic flow begins at step 401 where an over-the-air transmission (signal) is received from a subscriber module. At step 403 LFE 301 determines a range of the subscriber module based on a round-trip-delay of the received transmission and at step 405, RSS computer measures the received signal strength (receive power) of the received signal. Transmit-power computer 303 calculates the transmit power of the subscriber module based on the range of the subscriber module and the received signal strength of the received signal (step 407). (The transmit-power computer is calibrated prior to the installation of the equipment, or on site). Finally, at step 409, logic circuitry 304 receives the transmit power and determines whether to allow or deny network access based on the transmit power of the subscriber module. As discussed above, the subscriber module may be allowed network access if the subscriber module does not interfere with another transmitter, or if the subscriber module complies with regulatory conditions.

The decision to allow or deny network access can be passed to authentication equipment (not shown) that normally authenticates communications from subscriber modules. With this information, the authentication equipment will deny network access when logic circuitry 304 instructs it to do so. In a typical application, the cluster management module, also referred to as a Base Station or a Wireless Regional Area Network (WRAN), would have data processing associated with it that determines if a customer is properly credentialed. This could include billing/payment information, location of the device, services and data rates allowed, and, in this case, if proper equipment and transmit power levels are maintained. In a large network, this processing could also be completed at a distant, control site. Since the only timing information that is critical is the round trip CMM to subscriber module timing, as well as the received power level/profile, the actual denial of service processing can take place at any location that is integrally tied to the system.

FIG. 5 is a flow chart showing operation of the cluster management module of FIG. 2 in accordance with the second embodiment of the present invention. The logic flow begins at step 501 where an over-the-air signal is received from a subscriber module. At step 503 LFE 301 determines a range of the subscriber module, an azimuth of the received signal, and an approximate location of the module based on the range and azimuth. At step 505, RSS computer measures the received signal strength of the received signal. Transmit-power computer 303 calculates the transmit power of the subscriber module based on the range of the subscriber module and the received signal strength of the received signal (step 507). Finally, at step 509, logic circuitry 304 receives both the azimuth and the transmit power of the received signal and determines whether to allow or deny network access based on the transmit power of the subscribe unit and the azimuth and/or approximate location of the subscriber module.

Because cluster management module 101 will deny network access to those subscriber modules transmitting with power levels above FCC guidelines, substantial system cost reductions may be achieved since no truck roll will be necessary to make sure subscriber modules are transmitting within FCC guidelines. This allows for self-installation of subscriber modules by customer since performance can be verified. Additionally, network access will be denied if a customer tampers with the subscriber module in order to transmit with power levels above those allowed.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for allowing network access, the method comprising the steps of:
receiving a transmission from a subscriber module;
estimating a range for the subscriber module based on the received transmission;
measuring a receive power for the received transmission;
determining a transmit power for the subscriber module based on the range of the subscriber module and the receive power of the subscriber module; and
allowing or denying network access for the subscriber module based on the transmit power of the subscriber module.

2. The method of claim 1 further comprising the steps of:
determining an azimuth for the received transmission;
determining an approximate location of the subscriber module based on the azimuth and the range of the subscriber module; and
wherein the step of allowing of denying network access is additionally based on the location of the subscriber module.

3. The method of claim 2 wherein the subscriber module is allowed network access if the subscriber module does not interfere with another transmitter.

4. The method of claim 2 wherein the subscriber module is allowed network access if the subscriber module complies with regulatory conditions.

5. The method of claim 1 wherein the subscriber module is allowed network access if the subscriber module does not interfere with another transmitter.

6. The method of claim 1 wherein the subscriber module is allowed network access if the subscriber module complies with regulatory conditions.

7. The method of claim 1 wherein the step of estimating the range for the subscriber module comprises the step of estimating the range based on a round-trip delay.

8. The method of claim 1 wherein the step of determining the transmit power comprises the step of determining a power at which the subscriber module transmits.

9. A method for allowing network access, the method comprising the steps of:
receiving an over-the-air transmission from a subscriber module;
estimating a round-trip-delay for the over-the-air transmission;
estimating a range for the subscriber module based on the round-trip delay;
measuring a receive power for the over-the-air transmission;
determining a transmit power for the subscriber module based on the range of the subscriber module and the receive power of the subscriber module; and
allowing or denying network access for the subscriber module based on the transmit power of the subscriber module.

10. The method of claim 9 further comprising the steps of:
determining an azimuth for the over-the-air transmission;
determining an approximate location of the subscriber module based on the azimuth and the range of the subscriber module; and
wherein the step of allowing of denying network access for the subscriber module is additionally based on the location of the subscriber module.

11. The method of claim 9 wherein the step of determining the transmit power comprises the step of determining a power at which the subscriber module transmits.

12. The method of claim 9 further comprising the step of utilizing information gathered from multiple, nearby subscriber modules to refine a propagation model utilized to estimate the range for the subscriber module.

13. An apparatus comprising:
an access point receiving a transmission from a subscriber module;
location-finding equipment determines a range for the subscriber module based on the received transmission;
an RSS computer measuring a receive power for the received transmission;
a transmit-power computer determining a transmit power for the subscriber module based on the range of the subscriber module and the receive power of the subscriber module; and
logic circuitry allowing or denying network access for the subscriber module based on the transmit power of the subscriber module.

14. The apparatus of claim 13 further wherein:
the location-finding equipment additionally determines an azimuth for the received transmission and an approximate location of the subscriber module based on the azimuth and the range of the subscriber module; and
the logic circuitry allows or denies network access additionally based on the location of the subscriber module.

15. The apparatus of claim 13 wherein the subscriber module is allowed network access if the subscriber module does not interfere with another transmitter.

16. The apparatus of claim 13 wherein the subscriber module is allowed network access if the subscriber module complies with regulatory conditions.

17. The apparatus of claim 13 wherein the subscriber module is allowed network access if the subscriber module does not interfere with another transmitter.

18. The apparatus of claim 13 wherein the subscriber module is allowed network access if the subscriber module complies with regulatory conditions.

19. The apparatus of claim 13 wherein the location-finding equipment determines the range for the subscriber module based on a round-trip delay.

20. The apparatus of claim 13 wherein the transmit power comprises a power at which the subscriber module transmits.
